(19) United States
(12) Patent Application Publication
(10) Pub. No.: US 2014/0117899 A1
(43) Pub. Date: May 1, 2014

(54) POWER CONVERSION APPARATUS

(71) Applicant: Sumitomo Heavy Industries, Ltd., Tokyo, WA (US)

(72) Inventors: Yasuhisa Tasaka, Kanagawa (JP); Kenichi Kimijima, Kanagawa (JP)

(73) Assignee: SUMITOMO HEAVY INDUSTRIES, LTD., Tokyo (JP)

(21) Appl. No.: 14/147,176

(22) Filed: Jan. 3, 2014

Related U.S. Application Data
(63) Continuation of application No. PCT/JP2012/004303, filed on Jul. 3, 2012.

(30) Foreign Application Priority Data
Jul. 4, 2011 (JP) 2011-148543

(51) Int. Cl. B60L 11/18

(52) U.S. Cl. CPC B60L 11/1803
USPC 318/400.21

(57) ABSTRACT

A high-side transistor includes N (N represents an integer of two or more) high-side transistor units electrically arranged in parallel between a high-side power supply line and an output terminal for the corresponding phase. A low-side transistor includes N low-side transistor units electrically arranged in parallel between a low-side power supply line and an output terminal for the corresponding phase. A snubber circuit is provided for each pair of a high-side transistor unit and a corresponding low-side transistor unit. The high-side transistor, the low-side transistor, and the N snubber circuits are mounted on a metal base substrate.

### BACKGROUND OF THE INVENTION

1. Field of the Invention

The present invention relates to a power conversion apparatus.

2. Description of the Related Art

FIG. 1 is a circuit diagram showing a typical configuration of an electric power conversion apparatus (inverter) 2. The electric power conversion apparatus 2 is used to drive a load 4 such as an electric motor. The electric power conversion apparatus 2 includes: high-side transistors MHU, MHV, and MHW, respectively provided for the U phase, V phase, and W phase; low-side transistors MLU, MLV, and MLW, respectively provided for the U phase, V phase, and W phase; a gate drive circuit 10 which drives the high-side transistors MHU, MHV, and MHW and the low-side transistors MLU, MLV, and MLW for the respective phases; and snubber circuits 12U, 12V and 12W for the respective phases.

In a case in which a large current is supplied to a load, the high-side transistor MH and the low-side transistor ML are each configured as a large-capacity power transistor. Such a large-capacity power transistor can have a problem of poor circuit reliability when it is subjected to noise. In order to solve such a problem, there is a need to provide a large-capacity snubber circuit for such a large-capacity power transistor.

A snubber circuit having a large capacity is connected to the exterior of a power module (power transistor) via a bus bar. A typical power module includes silicon chips as built-in components, the number of which corresponds to the capacity of the power module.

With such a configuration, the distance between each of the silicon chips and the snubber circuit is not uniform. Thus, such an arrangement has a problem of an insufficient surge suppression effect with respect to transistors formed on a silicon chip which is arranged at a long electrical distance from the snubber circuit.

Furthermore, progress is being made in operating an inverter with a high frequency for industrial vehicles such as forklift trucks. With such an arrangement, there is a need to suppress high-frequency surge noise. However, a large-capacity snubber circuit is provided for each power module. This leads to each circuit element of the snubber circuit, such as a capacitor or the like, having an increased capacitance. As the capacitance of a capacitor becomes greater, the frequency characteristics of the capacitor become poor. This is why it is difficult for such an arrangement to suppress high-frequency surge noise.

Moreover, there is a great demand for such industrial vehicles to be resistant to vibration. The snubber circuit is configured using large-capacitor circuit components, i.e., large-size and heavy-weight circuit components, each of which is screwed onto a bus bar. Thus, with such an arrangement, there is a risk of vibration leading to deterioration in the long-term reliability of the circuit.

### SUMMARY OF THE INVENTION

The present invention has been made in order to solve such problems. Accordingly, it is an exemplary purpose of an embodiment of the present invention to provide a power conversion apparatus suitable for application to industrial vehicles.

An embodiment of the present invention relates to a power conversion apparatus which is mounted on a forklift truck, and configured to supply electric power to an electric motor. The power conversion apparatus comprises: a high-side power supply line; a low-side power supply line; high-side transistors each of which is provided for a corresponding phase, and each of which is arranged between the high-side power supply line and an output terminal for the corresponding phase; low-side transistors each of which is provided for a corresponding phase, and each of which is arranged between the low-side power supply line and an output terminal for the corresponding phase; N snubber circuits; and a metal base substrate.

The high-side transistor is configured comprising N (N represents an integer of two or more) high-side transistor units electrically arranged in parallel. The low-side transistor is configured comprising N low-side transistor units electrically arranged in parallel. The N snubber circuits are each provided for a corresponding pair of a high-side transistor unit and a corresponding low-side transistor unit. The high-side transistors, the low-side transistors, and the N snubber circuits are mounted on the metal base substrate.

With a set of a pair of a high-side transistor unit and a low-side transistor unit and a corresponding snubber circuit as a layout unit, N layout units are arranged on the metal base substrate in a regular manner. In each layout unit, the high-side transistor unit and the low-side transistor unit are arranged adjacent to each other in a first direction. The corresponding snubber circuit is arranged adjacent to the high-side transistor unit and the low-side transistor unit in a second direction that is orthogonal to the first direction.

Such an embodiment provides the following advantages.

First, the high-side transistor and the low-side transistor are each divided into multiple transistor units. Furthermore, a snubber circuit is arranged adjacent to each transistor unit. Thus, such an arrangement allows the electrical distance to be reduced between each snubber circuit and the corresponding transistor to be protected. This provides improved surge suppression effects.

Second, such an arrangement allows the length of the electric distance between the transistor unit and the snubber circuit to be the same for each layout unit. This prevents deterioration in reliability that can occur in a part of the transistor units.

Third, the snubber circuit is divided into N snubber circuit units. Such an arrangement allows a capacitor included in each snubber circuit unit to have a small capacitance, as compared with an arrangement in which a single snubber circuit is provided for the entire circuit made up of the high-side transistor and the low-side transistor. Thus, such an arrangement is capable of appropriately suppressing high-frequency surge noise.

Fourth, each component is mounted on the metal base substrate. Thus, such an arrangement allows the heat generated by each component to be released via the metal base substrate, thereby suppressing an increase in the temperature.

Fifth, each component of the snubber circuit is mounted on the metal base substrate. Thus, such an arrangement provides improved resistance to vibration, as compared with an arrangement in which each component of the snubber circuit is connected via a bus bar.

Based on the aforementioned advantages, such an embodiment can be suitable for application to industrial vehicles.

The metal base substrate may be configured in the form of separate sections physically divided in increments of layout units.

Such an embodiment suppresses heat transfer between adjacent layout units. That is to say, such an embodiment is capable of protecting the snubber circuit or the transistor included in each layout unit from heat generated by a transistor included in a different layout unit. Typically, repeated temperature changes lead to quick deterioration of a solder connection that connects circuit components or that connects a circuit component and a substrate. Such an embodiment relaxes the changes in the temperature, thereby providing improved long-term reliability.

Furthermore, the metal base substrate is divided into multiple sections in increments of layout units. Thus, in a case in which the designer designs several kinds of power conversion apparatuses configured to drive loads having different capacities, such an embodiment allows the designer to change the number of layout units in a simple manner. Thus, such an arrangement provides improved design efficiency without damaging the aforementioned advantages.

With an embodiment, a pair of slits may be provided such that the snubber circuit is interposed between the slits in the second direction.

Directing attention to the snubber circuit in a given layout unit, such an arrangement is capable of relaxing the effect of the transfer of heat from different layout units, in addition to relaxing the effect of the heat that occurs in the aforementioned given layout unit itself. Thus, such an arrangement provides improved long-term reliability.

The high-side transistor unit and the low-side transistor unit may each comprise two sub-transistor units adjacent to each other in the first direction. Also, the metal base substrate may be configured in the form of separate sections each provided for a corresponding one of the high-side transistor units and the low-side transistor units.

The high-side transistor unit and the low-side transistor unit may each comprise two sub-transistor units adjacent to each other in the first direction. Also, the metal base substrate may be configured in the form of separate sections provided for each pair of sub-transistor units.

Also, the N snubber circuits may each be configured as a C snubber circuit comprising a first capacitor and a second capacitor arranged in series between the high-side power supply line and the low-side power supply line. Also, the first capacitor may be arranged adjacent to the sub-transistor unit of the high-side transistor. Also, the second capacitor may be arranged adjacent to the sub-transistor unit of the low-side transistor.

Also, the N snubber circuits may each be configured as an RCD snubber circuit comprising: a third capacitor, a first diode, a second diode, and a fourth capacitor, sequentially arranged in series between the high-side power supply line and the low-side power supply line; a first resistor arranged between the low-side power supply line and a connection node that connects the third capacitor and the first diode; and a second resistor arranged between the high-side power supply line and a connection node that connects the second diode and the fourth capacitor. Also, the third capacitor and the first diode may be arranged adjacent to the sub-transistor unit of the corresponding high-side transistor. Also, the second diode and the fourth capacitor may be arranged adjacent to the sub-transistor unit of the corresponding low-side transistor.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing a typical configuration of a power conversion apparatus;

FIG. 2 is an equivalent circuit diagram showing a configuration of a power conversion apparatus according to an embodiment;

FIG. 3 is a plan view showing a configuration of the power conversion apparatus shown in FIG. 2;

FIG. 4 is a diagram showing a configuration of a power conversion apparatus according to a first modification;

FIG. 5 is a diagram showing a configuration of a power conversion apparatus according to a second modification;

FIG. 6 is a diagram showing a configuration of a power conversion apparatus according to a third modification;

FIGS. 7A and 7B are diagrams each showing an example configuration of the layout unit shown in FIG. 6;

FIGS. 8A and 8B are diagrams each showing another example configuration of the layout unit shown in FIG. 6; and

FIGS. 9A and 9B are diagrams each showing a configuration of a forklift truck.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not substantially affect the electric connection therebetween, or that does not damage the functions or effects of the connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not substantially affect the electric connection therebetween, or that does not damage the functions or effects of the connection therebetween, in addition to a state in which the member A is directly connected to the member C, or the member B is directly connected to the member C.

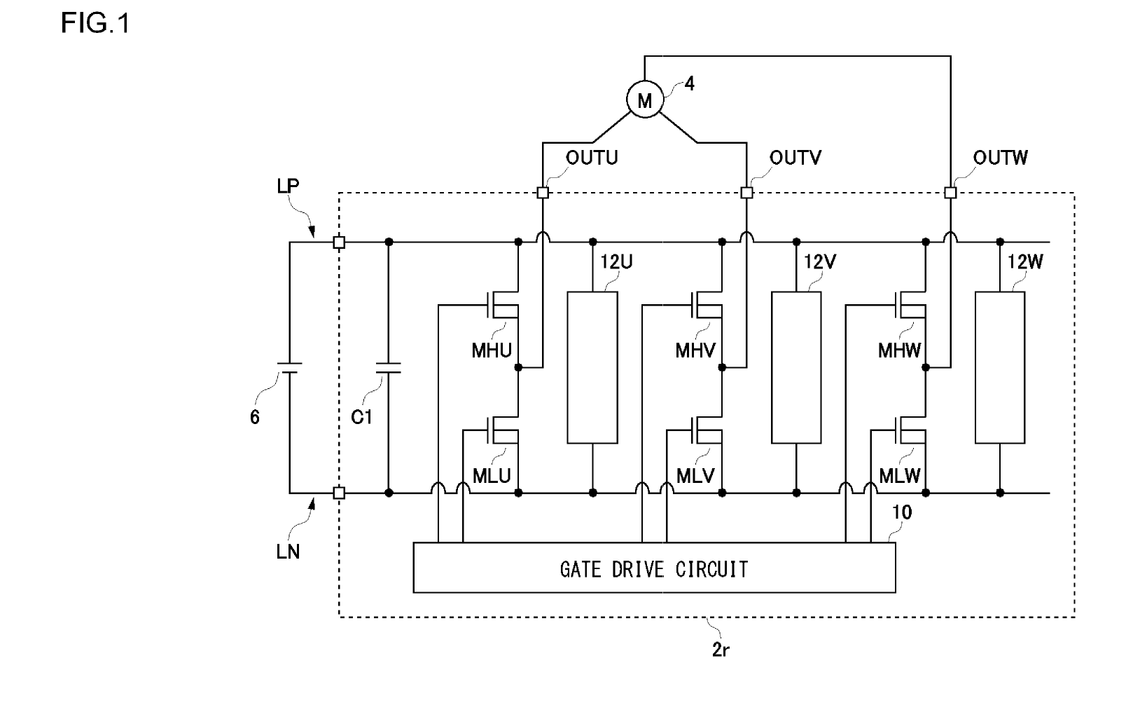

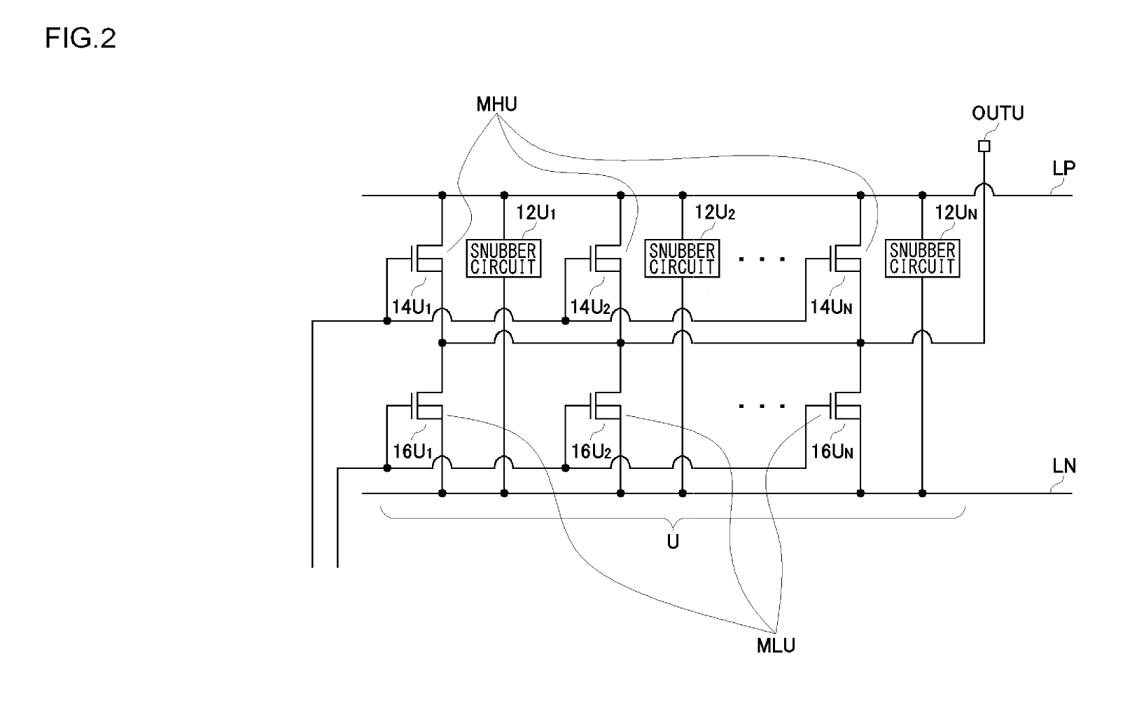

FIG. 2 is an equivalent circuit diagram showing a configuration of a power conversion apparatus 2 according to an embodiment. The power conversion apparatus 2 is mounted on an industrial vehicle such as a forklift truck or the like. The power conversion apparatus 2 drives a motor for handling cargo or otherwise a motor for driving wheels. The power conversion apparatus 2 has the same basic configuration as that of the power conversion apparatus 2r shown in FIG. 1. That is to say, the power conversion apparatus 2 includes: a high-side power supply line LP; a low-side power supply line LN; high-side transistors MHU, MHV, and MHW, which are arranged for the corresponding phases between the high-side power supply line LP and the corresponding output terminals OUTU, OUTV, and OUTW for the corresponding phases U, V, and W; and low-side transistors MLU, MLV, and MLW, which are arranged for the corresponding phases between the low-side power supply line LN and the corresponding output terminals OUTU, OUTV, and OUTW for the corresponding phases U, V, and W. FIG. 2 shows only a U-phase configuration. A V-phase configuration and a W-phase configuration are not shown. With the power conversion apparatus 2, the U-phase configuration, the V-phase configuration, and the W-phase configuration are configured in the same manner. Thus, description will be made regarding the features of the power conversion apparatus 2 with reference to the U-phase configuration.

The high-side transistor MH and the low-side transistor ML may be configured as a MOSFET (Metal Oxide Semiconductor Field Effect Transistor), IGBT (Insulated gate Bipolar transistor), or a bipolar transistor.

The high-side transistor MHU is configured including N (N represents an integer of 2 or more) high-side transistor units 14U₁ through 14U_{N} arranged electrically in parallel. In the same way, the low-side transistor MLU is configured including N low-side transistor units 16U₁ through 16U_{N} arranged electrically in parallel.

The power conversion apparatus 2 includes N snubber circuits 12U₁ through 12U_{N}. Each snubber circuit 12Uᵢ is provided for a corresponding transistor unit pair of a high-side transistor unit 14Uᵢ and a low-side transistor unit 16Uᵢ.

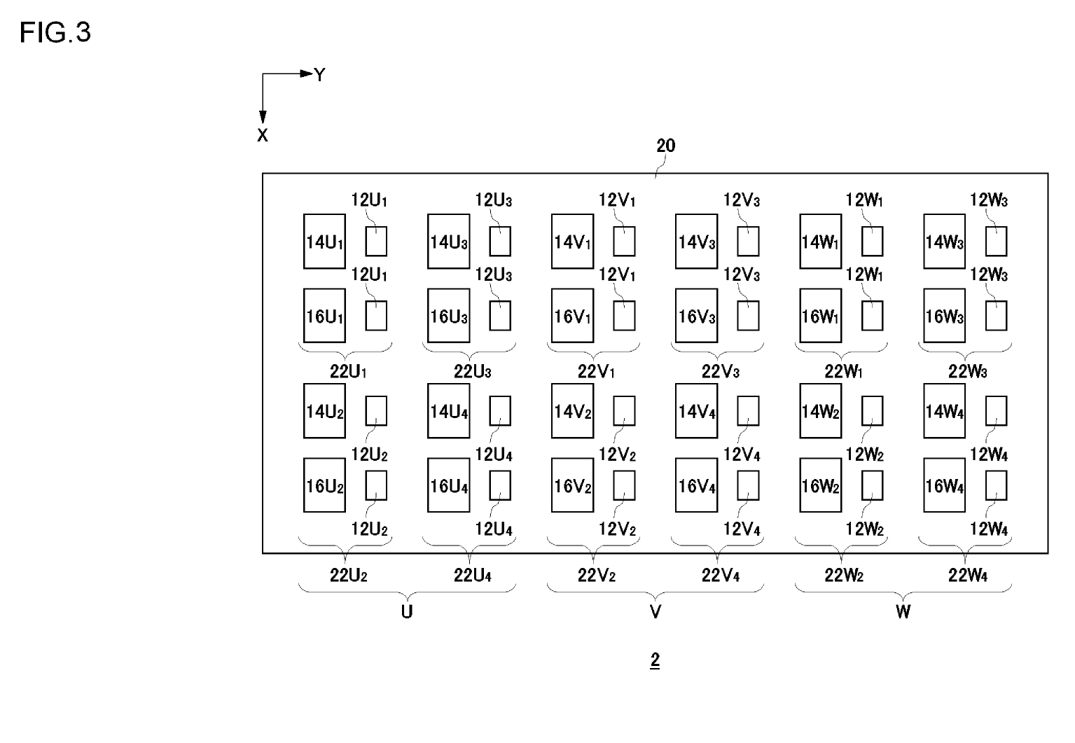

FIG. 3 is a plan view showing a configuration of the power conversion apparatus 2 shown in FIG. 2. FIG. 3 shows an arrangement in which N=4. The transistor units 14U₁ through 14U₄ that make up the high-side transistor MH, the transistor units 16U₁ through 16U₄ that make up the low-side transistor ML, and the N snubber circuits 12U₁ through 12U₄ are mounted on a metal base substrate 20.

Description will be made directing attention to the i-th (1≦i≦N) transistor unit. A pair of the high-side transistor unit 14Uᵢ and the low-side transistor unit 16Uᵢ and the corresponding snubber circuit 12Uᵢ make up a single layout unit 22Uᵢ. With such an arrangement, the N layout units 22U₁ through 22U₄ are arranged on the metal base substrate 20 in a regular manner.

In each layout unit 22Uᵢ, the high-side transistor unit 14Uᵢ and the low-side transistor unit 16Uᵢ are arranged adjacent to each other along a first direction X. Furthermore, each snubber circuit 12U₁ is arranged adjacent to a corresponding transistor unit (the high-side transistor unit 14Uᵢ or the low-side transistor unit 16Uᵢ) along a second direction Y that is orthogonal to the first direction X.

The above is the configuration of the power conversion apparatus 2. Such a power conversion apparatus 2 provides the following advantages.

Directing attention to the U-phase configuration, the high-side transistor MHU is divided into N transistor units 14U₁ through 14U_{N}, and the low-side transistor MLU is divided into N transistor units 16U₁ through 16U_{N}. Furthermore, the snubber circuit 12U is divided into N snubber circuit units. Such an arrangement allows each snubber circuit 12Uᵢ to be arranged adjacent to a corresponding transistor unit 14Uᵢ or 16Uᵢ. Thus, such an arrangement allows the electrical distance between each transistor to be protected and the corresponding snubber circuit to be reduced. Thus, such an arrangement provides improved surge suppression effects.

Such an arrangement allows the length of the electrical distance between each of the transistor units 14Uᵢ and 16Uᵢ and the corresponding snubber circuit 12Uᵢ to be the same for each layout unit 22Uᵢ. Thus, such an arrangement is capable of suppressing surge noise that can occur in each transistor unit. Thus, such an arrangement is capable of preventing a situation in which deterioration in reliability occurs in a part of the transistor units.

In a case in which a single snubber circuit is provided for all the pairs of high-side transistors and low-side transistors as shown in FIG. 1, such a configuration leads to an increase in the capacitance of the capacitors that form the snubber circuit 12. Such an arrangement is capable of appropriately suppressing low-frequency surge noise. However, it is difficult for such an arrangement to suppress high-frequency surge noise. In a case in which such a power conversion apparatus is employed for an advanced high-frequency operation forklift truck, such a poor surge noise suppression capability is a problem. In contrast, with the power conversion apparatus 2 according to the embodiment, each snubber circuit 12 is divided into N snubber circuit units 12U₁ through 12U_{N}. Such an arrangement allows each snubber circuit unit 12U to have a small capacitance, thereby appropriately suppressing high-frequency surge noise.

Furthermore, by mounting each component on the metal base substrate 20, such an arrangement allows the heat generated by each component to be released via the metal base substrate 20. Thus, such an arrangement suppresses an increase in the temperature of each component.

Furthermore, each component of the snubber circuit 12 is mounted on the metal base substrate 20. Thus, such an arrangement provides improved resistance to vibration, as compared with an arrangement in which such components are connected via a bus bar.

The power conversion apparatus 2 according to the embodiment provides the aforementioned advantages, thereby satisfying the requirements for industrial vehicles.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### First Modification

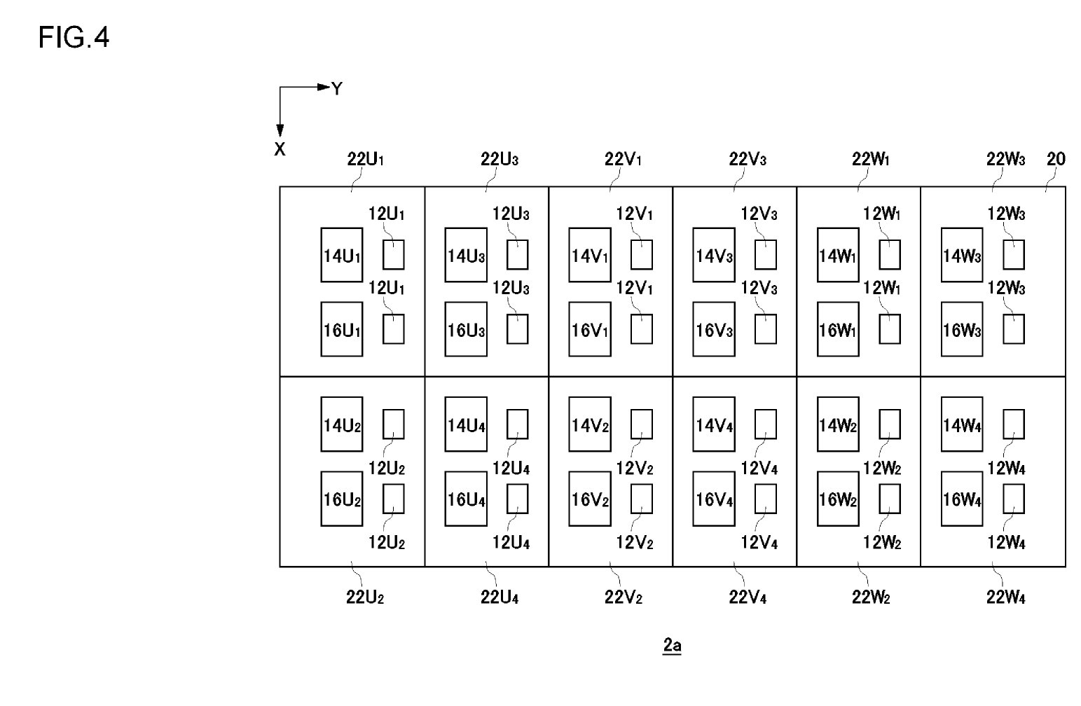

FIG. 4 is a diagram showing a configuration of a power conversion apparatus 2a according to a first modification.

The metal base substrate 20 is configured as physically separate sections each provided for a corresponding one of the layout units 22U. The adjacent layout units 22U may be fixed by screws.

Such a modification is capable of suppressing heat transfer between adjacent layout units 22U. Specifically, such a modification is capable of protecting the transistor units 14U and 16U or otherwise the snubber circuit 12U included in each layout unit 22U from heat generated by a transistor included in a different layout unit 22U. Such an arrangement is capable of suppressing changes in the temperature of the transistor units, the snubber circuit, and solder connections included in the layout unit 22U. This suppresses deterioration of such components, thereby providing improved long-term reliability.

Furthermore, such a modification allows the number of layout units 22U to be changed in a simple manner. Thus, such a modification allows the driving capacity (current capacity) of the power conversion apparatus to be changed in a simple manner. That is to say, such a modification provides improved design efficiency.

### Second Modification

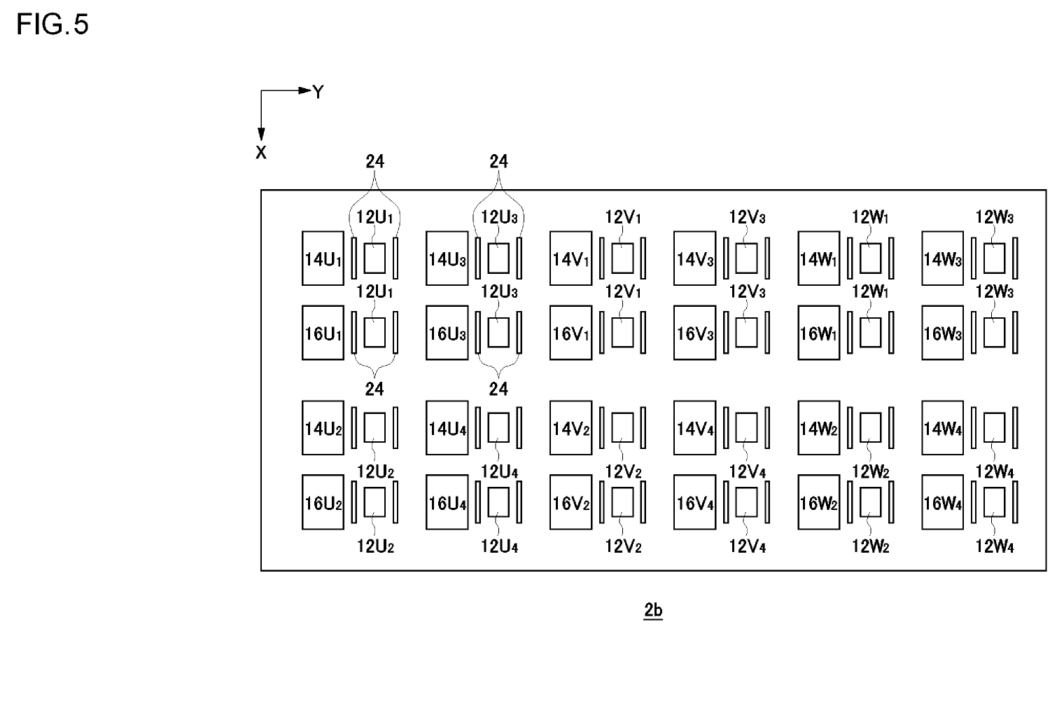

FIG. 5 is a diagram showing a configuration of a power conversion apparatus 2b according to a second modification.

In the metal base substrate 20, a pair of slits 24 is provided for each of the snubber circuits 12U₁ through 12U₄ such that each snubber circuit 12U is interposed between the slits arranged along the second direction Y.

With such a modification, directing attention to the snubber circuit 12Uᵢ of a given layout unit 22Uᵢ, one slit of the pair of slits 24 relaxes the thermal effects of the transistor units 14Uᵢ and 16Uᵢ of the same layout unit 22Uᵢ. Furthermore, the other slit of the pair of slits 24 relaxes the thermal effects of the transistor units 14Uⱼ and 16Uⱼ of the adjacent layout unit 22Uⱼ. Thus, such a modification provides improved long-term reliability.

The second modification may be combined with the first modification. That is to say, an arrangement may be made in which the metal base substrate 20 is divided in increments of layout units, and the pair of slits 24 is formed such that each snubber circuit 12 is interposed between the slits 24.

### Third Modification

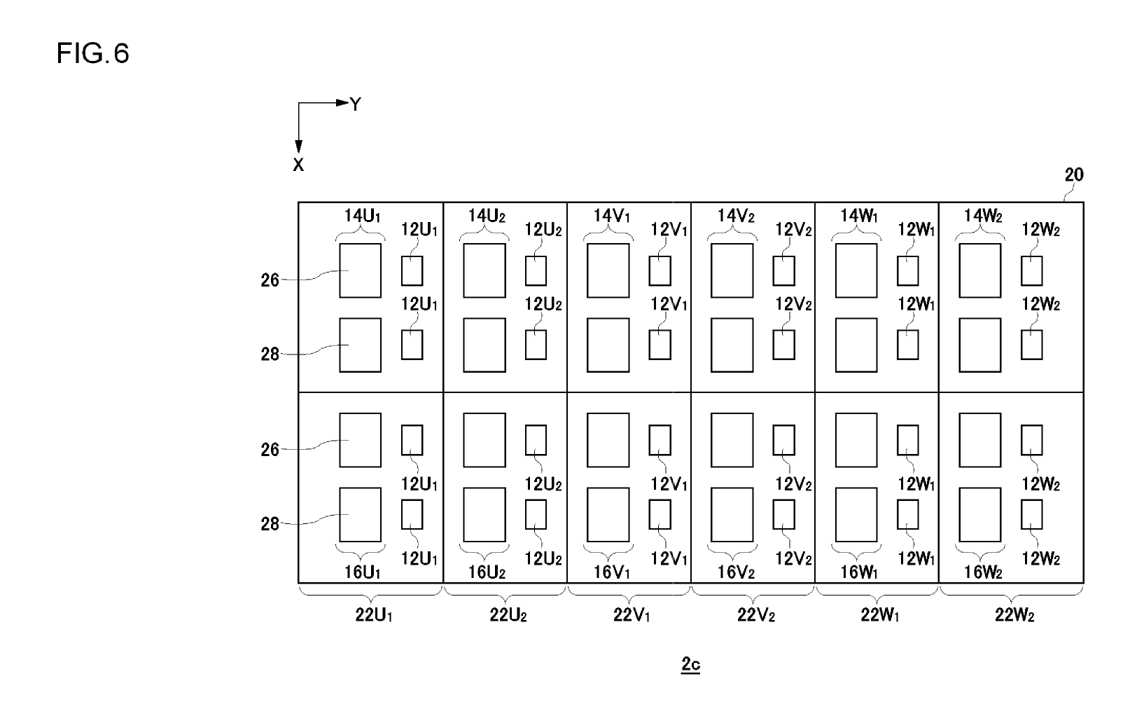

FIG. 6 is a diagram showing a configuration of a power conversion apparatus 2c according to a third modification.

With such a modification, the high-side transistor unit 14U and the low-side transistor unit 16U each include two sub-transistor units 26 and 28 adjacent to each other along the first direction X.

The metal base substrate 20 is divided in increments of high-side transistor units 14U and low-side transistor units 16U, instead of being divided in increments of layout units 22U.

Such a modification also provides the same advantages as those provided by the embodiment. Furthermore, by dividing the metal base substrate 20 into multiple sections, such a modification provides the same advantages as those provided by the first modification.

It should be noted that the terms “sub-transistor unit” and “transistor unit” are assigned for convenience of description. The sub-transistor units shown in FIG. 6 correspond in function to the transistor units shown in FIGS. 3 through 5. If the sub-transistor units shown in FIG. 6 are regarded as transistor units, the power conversion apparatus 2c can also be understood as follows.

With the power conversion apparatus 2c, the high-side transistor MHU is configured including N (=K×L) (K and L each represent an integer of 2 or more) high-side transistor units electrically arranged in parallel. FIG. 6 shows an example in which K=2 and L=2. In the same manner, the low-side transistor MLU is configured including (K×L) low-side transistor units electrically arranged in parallel.

The power conversion apparatus 2c shown in FIG. 6 includes L snubber circuits. Each snubber circuit 12U is provided for a set made up of K high-side transistor units and the corresponding K low-side transistor units.

With such an arrangement, K high-side transistor units, K low-side transistor units and the corresponding snubber circuit 12U make up a layout unit 22U. The L layout units 22U are arranged on the metal base substrate 20 in a regular manner.

In each layout unit 22U, the K high-side transistor units are arranged adjacent to the K low-side transistor units. Furthermore, each snubber circuit 12U is arranged adjacent to the corresponding one of the K high-side transistor units and the K low-side transistor units in the second direction Y that is orthogonal to the first direction X.

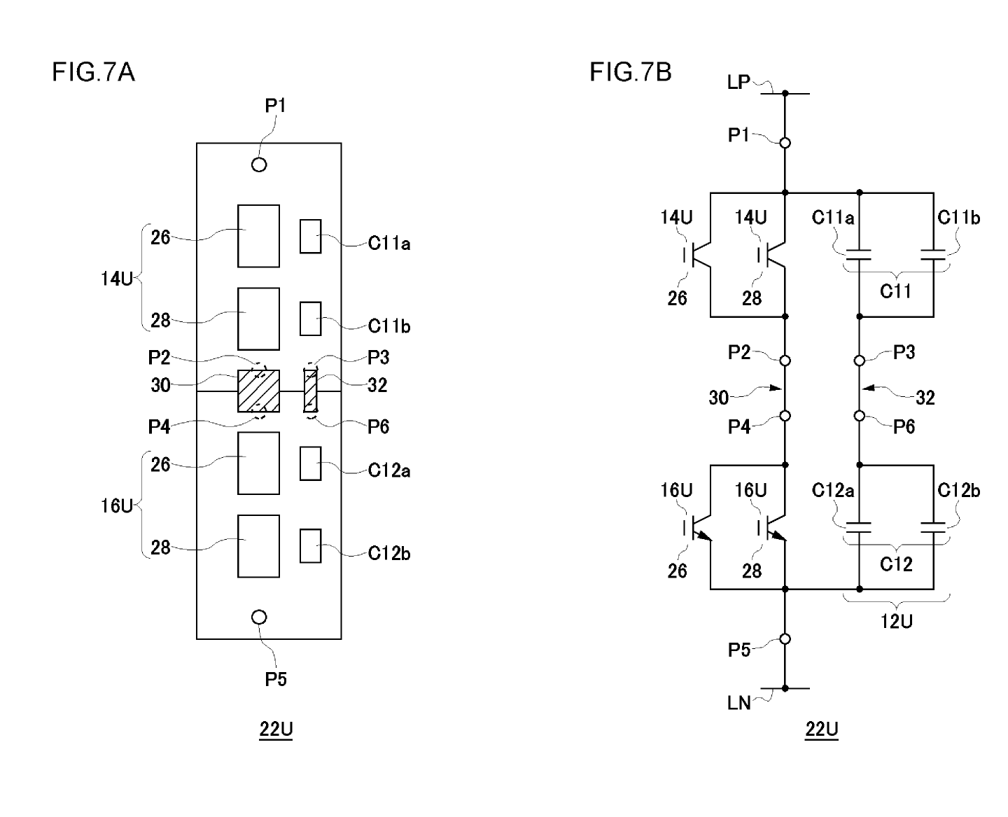

FIGS. 7A and 7B are diagrams each showing an example configuration of the layout unit 22U shown in FIG. 6. FIG. 7A shows the layout on the base substrate. FIG. 7B shows an equivalent circuit diagram. The snubber circuit shown in FIG. 7B is configured as a C snubber circuit. The snubber circuit 12U includes a first capacitor C11 and a second capacitor C12 arranged in series between the high-side power supply line LP and the low-side power supply line LN. The first capacitor C11 includes two capacitors C11a and C11b arranged in parallel. The first capacitor C11 is arranged adjacent to the sub-transistor units 26 and 28 that make up the high-side transistor unit 14U. Similarly, the second capacitor C12 includes two capacitors C12a and C12b arranged in parallel. The second capacitor C12 is arranged adjacent to the sub-transistor units 26 and 28 that make up the low-side transistor unit 16U. The adjacent separate metal base substrates are connected to each other via jumpers (metal plates) 30 and 32.

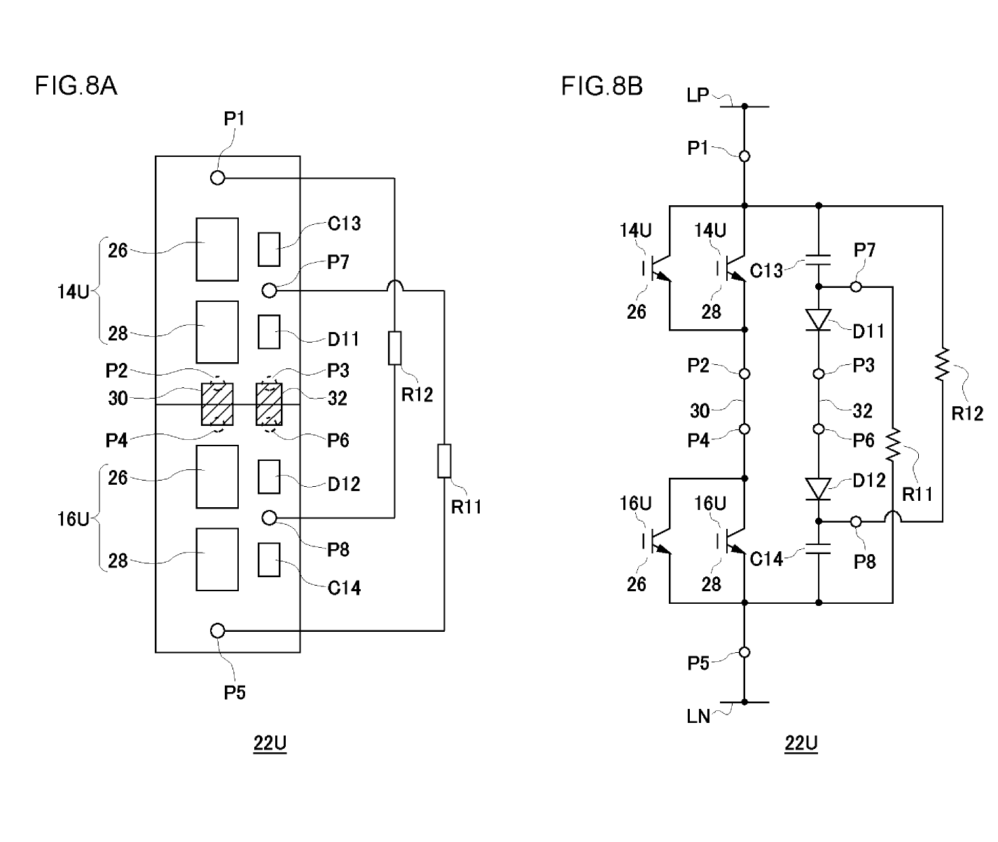

FIGS. 8A and 8B are diagrams each showing another example configuration of the layout unit 22U shown in FIG. 6. FIG. 8A shows the layout on the base substrate. FIG. 8B shows an equivalent circuit diagram. The snubber circuit shown in FIG. 8B is configured as an RCD snubber circuit. The snubber circuit 12U includes a third capacitor C13, a first diode D11, a second diode D12, and a fourth capacitor C14 arranged in series between the high-side power supply line LP and the low-side power supply line LN. The snubber circuit 12U further includes a first resistor R11 arranged between the low-side power supply line LN and a connection node P7 that connects the third capacitor C13 and the first diode D11, and a second resistor R12 arranged between the high-side power supply line LP and a connection node P8 that connects the second diode D12 and the fourth capacitor C14.

The third capacitor C13 and the first diode D11 are arranged adjacent to the sub-transistor units 26 and 28 that make up the high-side transistor unit 14U. Furthermore, the second diode D12 and the fourth capacitor C14 are arranged adjacent to the sub-transistor units 26 and 28 that make up the low-side transistor unit 16U.

The resistors R11 and R12 are each have a sufficiently high resistance as compared with the wiring resistance. Accordingly, even if each of the resistors R11 and R12 is arranged at a large distance from the transistors, such an arrangement does not influence the performance of the snubber circuit. Thus, the first resistor R11 and the second resistor R12 are arranged as components external to the metal base substrate 20.

With such configurations shown in FIGS. 6 through 8, a circuit component of the snubber circuit is associated with each of the sub-transistor units 26 and 28. Thus, such an arrangement provides a highly efficient layout.

Description will be made regarding the usage of the aforementioned power conversion apparatus 2. The power conversion apparatus 2 can be suitably employed in forklift trucks with advanced high-frequency operation, and which require resistance to vibration.

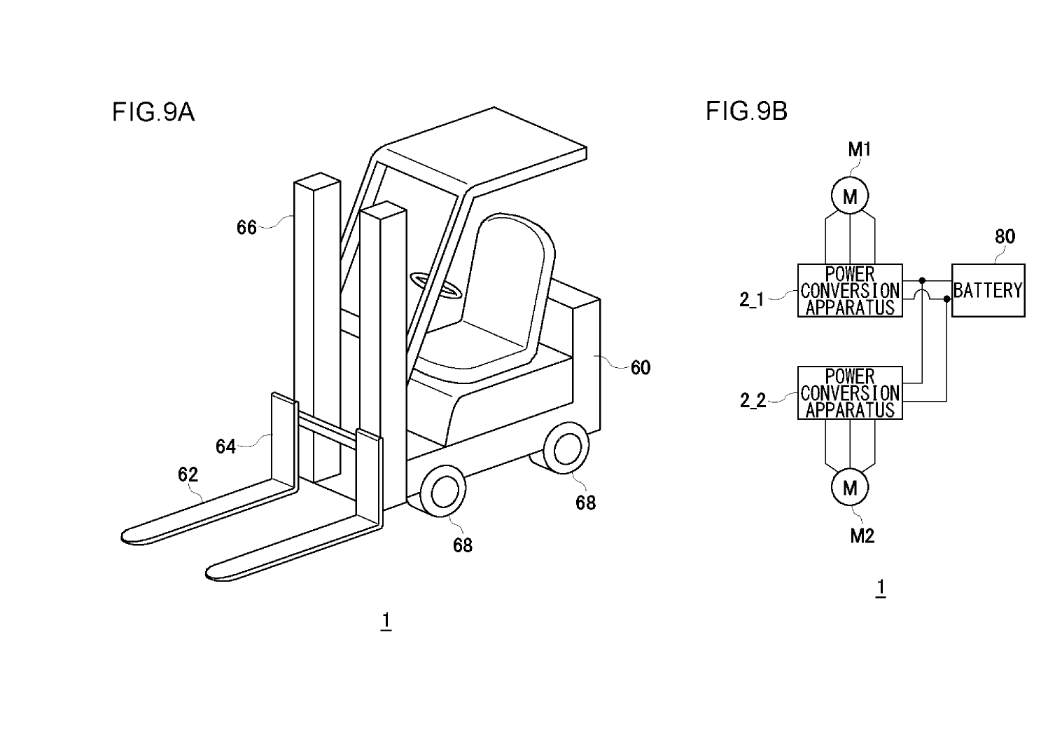

FIGS. 9A and 9B are diagrams each showing a configuration of a forklift truck. As shown in FIG. 9A, a forklift truck 1 includes a main body 60, forks 62, a lift 64, masts 66, and wheels 68. The masts 66 are provided to the front of the main body 60. The lift 64 is driven by a driving source such as a hydraulic pump or the like (not shown), thereby allowing the lift 64 to be moved in the vertical direction. The forks 62 are mounted on the lift 64 in order to support cargo.

FIG. 9B is a diagram showing an electrical system configuration of the forklift truck 1. The forklift truck 1 includes two electric motors M1 and M2 for two electrical systems. The first electric motor M1 is configured as a motor for driving wheels which rotates the wheels 68. The second electric motor M2 is configured as a motor for handling cargo used to control a hydraulic actuator which moves the lift 64 in the vertical direction. Power conversion apparatuses 2_1 and 2_2 each receive DC voltage from a battery 80, converts the DC voltage thus received into a three-phase AC signal, and supplies the three-phase AC signal thus converted to the electric motors M1 and M2. The battery 80, the power conversion apparatuses 2_1 and 2_2, and the electric motors M1 and M2 are fixedly mounted on the main body 60. The power conversion apparatuses 2_1 and 2_2 may be configured in the form of separate modules, or otherwise may be configured as a single module.

From the viewpoint of its improved resistance to vibration and improved high-frequency surge noise suppression capability, the aforementioned power supply apparatus can be suitably employed in such a forklift truck 1.

Description has been made in the embodiment regarding the power conversion apparatus 2 which drives a three-phase electric motor. However, with the present invention, such an electric motor to be driven is not restricted to such a three-phase electric motor. Rather, the present invention is applicable to various kinds of two or more phase multi-phase motors. Description has been made in the embodiment regarding an arrangement in which the electric motor 4 is directly connected to the power conversion apparatus 2. Also, the power conversion apparatus 2 and the motor 4 may be connected to each other via another conversion apparatus or another circuit block.

While the preferred embodiments of the present invention have been described using specific terms, such description is for illustrative purposes only, and it is to be understood that changes and variations may be made without departing from the spirit or scope of the appended claims.

What is claimed is:

1. A power conversion apparatus which is mounted on a forklift truck, and configured to supply electric power to an electric motor, the power conversion apparatus comprising:
a high-side power supply line;
a low-side power supply line;
high-side transistors each of which is provided for a corresponding phase, and each of which is arranged between the high-side power supply line and an output terminal for the corresponding phase, and each of which is configured comprising N (N represents an integer of two or more) high-side transistor units electrically arranged in parallel;
low-side transistors each of which is provided for a corresponding phase, and each of which is arranged between the low-side power supply line and an output terminal for the corresponding phase, and each of which is configured comprising N low-side transistor units electrically arranged in parallel;
N snubber circuits each of which is provided for a corresponding pair of a high-side transistor unit and a corresponding low-side transistor unit; and
a metal base substrate on which the high-side transistors, the low-side transistors, and the N snubber circuits are mounted,
wherein, with a set of a pair of a high-side transistor unit and a low-side transistor unit and a corresponding snubber circuit as a layout unit, N layout units are arranged on the metal base substrate in a regular manner,
and wherein, in each layout unit, the high-side transistor unit and the low-side transistor unit are arranged adjacent to each other in a first direction, and the corresponding snubber circuit is arranged adjacent to the high-side transistor unit and the low-side transistor unit in a second direction that is orthogonal to the first direction.

2. The power conversion apparatus according to claim 1, wherein the metal base substrate is configured in the form of separate sections in increments of the layout units.

3. The power conversion apparatus according to claim 1, wherein a pair of slits is provided such that the snubber circuit is interposed between the slits in the second direction.

4. The power conversion apparatus according to claim 1, wherein the high-side transistor unit and the low-side transistor unit each comprise two sub-transistor units arranged adjacent to each other in the first direction,
wherein the metal base substrate is configured in the form of separate sections each provided for a corresponding one of the high-side transistor units and the low-side transistor units.

5. The power conversion apparatus according to claim 4, wherein the N snubber circuits are each configured as a C snubber circuit comprising a first capacitor and a second capacitor arranged in series between the high-side power supply line and the low-side power supply line,
and wherein the first capacitor is arranged adjacent to the sub-transistor unit of the high-side transistor,
and wherein the second capacitor is arranged adjacent to the sub-transistor unit of the low-side transistor.

6. The power conversion apparatus according to claim 4, wherein the N snubber circuits each configured as an RCD snubber circuit comprising:
a third capacitor, a first diode, a second diode, and a fourth capacitor, sequentially arranged in series between the high-side power supply line and the low-side power supply line;
a first resistor arranged between the low-side power supply line and a connection node that connects the third capacitor and the first diode; and
a second resistor arranged between the high-side power supply line and a connection node that connects the second diode and the fourth capacitor,
and wherein the third capacitor and the first diode are arranged adjacent to the sub-transistor unit of the corresponding high-side transistor,
and wherein the second diode and the fourth capacitor are arranged adjacent to the sub-transistor unit of the corresponding low-side transistor.

7. A power conversion apparatus which is mounted on a forklift truck, and configured to supply electric power to an electric motor, the power conversion apparatus comprising:
a high-side power supply line;
a low-side power supply line;
high-side transistors each of which is provided for a corresponding phase, and each of which is arranged between the high-side power supply line and an output terminal for the corresponding phase, and each of which is configured comprising (K×L) (K and L each represent an integer of two or more) high-side transistor units electrically arranged in parallel;
low-side transistors each of which is provided for a corresponding phase, and each of which is arranged between the low-side power supply line and an output terminal for the corresponding phase, and each of which is configured comprising (K×L) low-side transistor units electrically arranged in parallel;
L snubber circuits each of which is provided for a corresponding set of K high-side transistor units and K low-side transistor units; and
a metal base substrate on which the K high-side transistors, the K low-side transistors, and the N snubber circuits are mounted,
wherein, with a set of the K high-side transistor units and the K low-side transistor units and the corresponding snubber circuit as a layout unit, L layout units are arranged on the metal base substrate in a regular manner,
and wherein, in each layout unit, the K high-side transistor units and the K low-side transistor units are arranged adjacent to one another in a first direction, and the corresponding snubber circuit is arranged adjacent to the K high-side transistor units and the K low-side transistor units in a second direction that is orthogonal to the first direction.
